(19) United States
(12) Patent Application Publication
(10) Pub. No.: US 2025/0254662 A1
(43) Pub. Date: Aug. 7, 2025

(54) USER EQUIPMENT AND RESOURCE SELECTION METHOD FOR SIDELINK COMMUNICATION

(71) Applicant: GUANGDONG OPPO MOBILE TELECOMMUNICATIONS CORP., LTD., Dongguan (CN)

(72) Inventor: Huei-Ming LIN, Taipei (TW)

(21) Appl. No.: 19/186,441

(22) Filed: Apr. 22, 2025

Related U.S. Application Data
(63) Continuation of application No. PCT/CN2022/139740, filed on Dec. 16, 2022.

(51) Int. Cl. H04W 72/02; H04W 24/08; H04W 72/40; H04W 74/0808

(52) U.S. Cl. CPC H04W 72/02; H04W 24/08; H04W 72/40; H04W 74/0808

(57) ABSTRACT

A resource selection method for sidelink communication by a UE includes performing resource selection based on at least one of followings: selecting resources from consecutive RB sets for sidelink transmission, avoid selecting resources in a same slot from different RB sets for simultaneous transmission, selecting resources in consecutive time slots within a COT duration and within a same RB set, prioritizing or selecting resources for sidelink transmission within a self-initiated COT of the UE or a shared COT from another UE and within a same RB set as the self-initiated COT or the shared COT when a priority class of the sidelink transmission is equal to or larger than the self-initiated COT or the shared COT, performing CBR and/or a channel CR measurements per RB set and prioritizing/selecting a less loaded/congested RB set with lower measured CBR and/or CR values based on the CBR and/or the CR measurements, etc.

### CROSS-REFERENCE TO RELATED APPLICATION(S)

This application is a continuation of International Application No. PCT/CN 2022/139740, filed Dec. 16, 2022, the entire disclosure of which is hereby incorporated by reference.

### BACKGROUND OF DISCLOSURE

### 1. Field of the Disclosure

The present disclosure relates to the field of communication systems, and more particularly, to a user equipment (UE) and a resource selection method for sidelink communication, which can provide a good communication performance and/or provide high reliability.

### 2. Description of the Related Art

In the advancement of radio wireless transmission and reception directly between two devices, which is often known as device-to-device (D2D) communication, it was first developed by 3rd generation partnership project (3GPP) and introduced in Release 12 (officially specified as sidelink communication) and improved in Release 13 for public safety emergency usage such as mission critical communication to support mainly low data rate and voice type of connection. In 3GPP Release 14, 15, and 16, the sidelink technology was advanced to additionally support vehicle-to-everything (V2X) communication as part of global development of intelligent transportation system (ITS) to boost road safety and advanced/autonomous driving use cases. To further expand the support of sidelink technology to wider applications and devices with limited power supply/battery, the technology was further enhanced in Release 17 in the area of power saving and transceiver link reliability. For Release 18, 3GPP is currently looking to evolve the wireless technology and expand its operation into unlicensed frequency spectrum for larger available bandwidth, faster data transfer rate, and easier market adoption of D2D communication using sidelink without requiring any mobile cellular operator's involvement to allocate and configure a part of their expansive precious radio spectrum for data services that do not go throughput their mobile networks.

Therefore, there is a need for a user equipment (UE) and a resource selection method for sidelink communication, which can solve issues in the prior art, gain higher success in accessing the unlicensed/shared channel(s) for sending sidelink (SL) data information, avoid uneven wireless traffic load across different unlicensed/shared channels, provide less radio transmission peak-to-average power ratio (PAPR) issue, utilize more radio resource, avoid fragmentation of frequency resources, provide a good communication performance, and/or provide high reliability.

### SUMMARY

In a first aspect of the present disclosure, a resource selection method for sidelink communication by a user equipment (UE) includes performing resource selection, by the UE, based on at least one of followings: selecting consecutive resources from resource block (RB) sets for sidelink transmission, avoid selecting resources in a same slot from different RB sets for simultaneous transmission, selecting resources in consecutive time slots within a channel occupancy time (COT) duration and within a same RB set, prioritizing or selecting resources for sidelink transmission within a self-initiated COT of the UE or a shared COT from another UE and within a same RB set as the self-initiated COT or the shared COT when a priority class of the sidelink transmission is equal to or larger than the self-initiated COT or the shared COT, performing channel busy ratio (CBR) and/or a channel occupancy ratio (CR) measurements per RB set and prioritizing or selecting a less loaded/congested RB set with lower measured CBR and/or CR values based on the CBR and/or the CR measurements, avoid selecting or exclude resources of an entire RB set based on one or more past listen-before-talk (LBT) failure reporting or a consistent LBT failure determination/indication, and prioritizing or selecting resources from one or both edge RB sets in a resource pool.

In a second aspect of the present disclosure, a user equipment (UE) includes a memory storing instructions, a transceiver, and a processor coupled to the memory and the transceiver. When the instructions is executed by the processor, the UE is caused to perform the above method.

In a third aspect of the present disclosure, a non-transitory machine-readable storage medium has stored thereon instructions that, when executed by a computer, cause the computer to perform the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of user equipments (UEs) of communication in a communication network system according to an embodiment of the present disclosure.

FIG. 2 is a schematic diagram illustrating a user plane protocol stack according to an embodiment of the present disclosure.

FIG. 3 is a schematic diagram illustrating a control plane protocol stack according to an embodiment of the present disclosure.

FIG. 4 is a flowchart illustrating a resource selection method for sidelink communication by a UE according to an embodiment of the present disclosure.

FIG. 5 is a schematic diagram illustrating one of the proposed resource selection methods for SL communication in an unlicensed spectrum band (SL-U) communication based on selecting resources according to an embodiment of the present disclosure.

FIG. 6 is a schematic diagram illustrating one of the proposed resource selection methods for SL-U communication based on selecting resources according to an embodiment of the present disclosure.

FIG. 7 is a block diagram of a UE for wireless communication according to an embodiment of the present disclosure.

FIG. 8 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

### Unlicensed/Shared Spectrum

Traditionally, the shared (also referred as unlicensed or license-exempted) radio spectrum in 2.4 GHz, 5 GHZ, and 6 GHz frequency bands are commonly used by Wi-Fi and Bluetooth wireless technologies for short range communication (from just a few meters to few tens of meters). It is often claimed that more traffic is carried over the unlicensed spectrum bands than any other radio bands, since the frequency spectrum is free/at no-cost to use by anyone as long as the communication devices are compliant to certain technical regulations set out in each region. Besides Wi-Fi and Bluetooth, other radio access technologies (RATs) such as licensed-assisted access (LAA) based on 4G-LTE and new radio unlicensed (NR-U) based on 5G-NR mobile systems from 3GPP also operate in the same unlicensed bands. In order for devices of different RATS (Wi-Fi, Bluetooth, LAA, NR-U, and possibly others) to operate simultaneously and coexistence fairly in the same geographical area without causing severe interference and interruption to each other's transmission, a clear channel access (CCA) protocol such as listen-before-talk (LBT) adopted in LAA and NR-U and carrier sense multiple access/collision avoidance (CSMA/CA) used in Wi-Fi and Bluetooth are performed before any wireless transmission is carried out to ensure that a wireless radio does not transmit while another is already transmitting on the same channel.

For the sidelink wireless technology to operate and also coexistence with existing RATs already operating in the unlicensed bands, LBT based schemes can be employed to make certain there is no on-going activity on the radio channel before attempting to access the channel for transmission. For example, when a type 1 LBT is successfully performed by a sidelink user equipment (UE), the UE has the right to access and occupy the unlicensed channel for a duration of a channel occupancy time (COT). This is called COT initiation. During an acquired COT, however, a device of another RAT could still gain access to the channel if no wireless transmission is performed by the COT initiation sidelink UE or a COT responding sidelink UE for an idle period longer than a pre-defined length (e.g., 16 μs or 25 μs). Hence, potentially losing the access to the channel until another successful LBT is performed. A potential solution to this issue of losing the access to the channel could be a back-to-back (B2B) transmission.

### B2B Transmission/Multi-Consecutive Slots Transmission (MCSt)

The main purpose of B2B transmission (which can be also referred as “burst transmission” or “multi-consecutive slot transmission”) is intended for a sidelink (SL) communicating UE to occupy an unlicensed channel continuously for a longer duration of time (i.e., more than one time slot) to mitigate the risk of losing access to the unlicensed channel to a wireless transmission (Tx) device of another radio access technology (RAT). This B2B transmission can be particular important and useful for a SL Tx-UE operating in an unlicensed radio frequency spectrum that has a large size of data transport block (TB) or medium access control (MAC) packet data unit (PDU), requires multiple retransmissions, sidelink hybrid automatic repeat request (SL-HARQ) feedback is disabled, and/or with a short latency requirement (small packet delay budget, PDB). When the unlicensed wireless channel is busy/congested (e.g., with many devices trying to access the channel simultaneously for transmission), it can be difficult and take up a long time to gain access to the channel due to the random backoff timer and priority class category in the LBT procedure. And hence, when a UE finally has a chance/opportunity to gain access to the wireless channel for a channel occupancy time (COT) length which may last for a few milliseconds (e.g., 2 ms, 4 ms, 6 ms, or 10 ms), the intention is to retain the channel access for as long as possible (e.g., all or most of the COT length) to send as much data as possible by continuously transmitting in the unlicensed channel such that wireless devices of other RATs would not have a chance to access the channel.

### Unlicensed Channel Access and Occupancy

As mentioned previously, a type 1 LBT procedure can be perform by a UE before any SL transmission to first gain an access to an unlicensed channel and to initiate a COT. Additionally, a B2B transmission could be used to avoid large transmission gaps in order to retain the COT and the access to the channel. Beside the type 1 LBT, a type 2 LBT could be also used by the UE during a COT or a shared COT as required by unlicensed spectrum regulation for gaps that are 25 μs or smaller. For example, in a type 2A LBT if an unlicensed channel is sensed to be idle for 25 μs or more, the COT initiating UE is permitted to resume its transmission, and/or a COT sharing UE is allowed to start its transmission within a COT. In a type 2B LBT, the allowed transmission gap is 16 μs and type 2C LBT (for which the UE does not need to perform channel sensing) is for gaps less than 16 μs.

In the LAA and NR-U systems, transmission gaps are unavoidable/inevitable before UE occupying the unlicensed channel due to propagation delay between gNB/eNB to the UEs in sending scheduling control information, UE switching from a receiving mode (RX) to a transmitting mode (TX), and data information encoding and modulation for an actual uplink (UL) transmission. Sometimes, these gaps could be larger than 25 μs and an extension of cyclic prefix may be first transmitted in the UL in order to avoid the unlicensed channel being taken over by other devices operating in the same spectrum band due to excessive channel idle time). The duration of the such cyclic prefix extension (CPE) transmission in the UL is determined by the base station (gNB/eNB) to avoid any access blocking/denying issue among different UEs and it is indicated to each scheduled UE, and the UE simply follows the indication and performs UL transmission accordingly.

In SL communication, especially in resource allocation (RA) mode 2, all transmission resources are to be determined and selected by the UE on its own without any base station intervention, assistance, and coordination to avoid transmission collisions. Furthermore, the SL system enables frequency domain multiplexing (FDM) of transmissions from multiple UEs in the same slot such that radio resource utilization efficiency is maximized and shortened the communication latency at the same time. But since there is no base station control and assistance to SL UEs in accessing the unlicensed channel(s), even in RA mode 1 under a gNB scheduling, the UEs may try to access the channel at different time and using different LBT channel access procedures with different channel idle period requirements. Under this type of operating scenario, it is not possible to coordinate in advanced among the UEs transmitting in the same slot to avoid access blocking/denying to the unlicensed channel.

### Channel Access for Multiple Unlicensed/Shared Channels

Typically for an unlicensed spectrum band in 5 GHz and 6 GHz frequency range, which are the target unlicensed bands for SL communication, the total bandwidth can be quite large in the order of hundreds of megahertz (MHz). According to unlicensed frequency allocation plans, a block of at least 100 MHz continuous bandwidth is available in most countries. For many applications, the use of a such large bandwidth is not necessary to transmit small packets. Since the design of wireless transmission of most RATs in the unlicensed spectrum is based on a time division multiplexing (TDM) scheme, where one device can transmit at a time, transmitting a small packet but occupying the entire bandwidth would not be a very spectral efficient use of the radio frequency. As such, an unlicensed spectrum band is divided into multiple smaller unlicensed/shared channels, and a wireless transmitting device determines any number of required unlicensed/shared channels and performs LBT channel access procedures for the selected unlicensed/shared channels before the transmission. Currently, since 20 MHz is the most common used bandwidth size and one of the smallest bandwidths adopted around the world for the unlicensed/shared channel access, 3GPP adopted the same 20 MHz bandwidth per unlicensed/shared channel definition for the unlicensed bands as the basic unit (a set of resource blocks; RB set) in LAA and NR-U for performing a LBT channel access procedure by eNB/gNB and UE. It is expected the same may be adopted for SL communication in the unlicensed bands as well. In the case when a UE requires more than one unlicensed/shared channel (RB set) for transmission of a large data packet, the UE needs to perform LBT channel access procedure in each one of the required and selected unlicensed channels/RB sets individually. And only when all of the channel access procedures are a success, the UE then gains the access to these channels/RB sets and allows to transmit the large data packet across these multiple channels/RB sets. If any one of the LBT channel access procedure is a failure (e.g., channel is busy), nothing can be transmitted by the UE in these selected multiple channels/RB sets (i.e., even if a success for some of the channels/RB sets).

### Mode 2 Resource Allocation Mechanism in Sidelink

In the existing design of resource allocation mechanism for SL communication, a mode 2 resource selection method relies on the SL transmitting UE to perform autonomous selection of resources from a SL resource pool for its own transmission of data messages. In this method, the selection of transmission resources is not random but based on a sensing and reservation strategy to avoid collision with other SL transmission UEs operating in the same resource pool. In this resource selection strategy, a transmitting UE senses the channel within a sensing window (which is different from the LBT channel sensing) to detect and decode SL resource reservation information from other transmitting UEs. Based on the received resource reservation information, the UE excludes the reserved resources from selection to avoid TX collision. Likewise, the UE also sends out/broadcast its own resource reservation information in the resource pool when it transmits data and control messages, so that other UEs may avoid selecting the same or an overlap resource. In the existing resource selection and reservation signaling design, the time gap between two consecutive resources for reservation can be up to 31 slots apart. With this type of resource selection method, it is not ideal for MCSt as there is no guarantee that resources may be selected contiguously in time.

In some embodiments, for the present proposed resource allocation methods for sidelink (SL) communication in more than one unlicensed/shared channel (RB set), SL radio resources are selected by a transmitting UE (Tx-UE) in a manner that is more conscious to the LBT channel access process and compliant to certain selection rules in order to gain higher success in accessing the unlicensed/shared channel(s) for sending sidelink data information and to avoid uneven wireless traffic (including transmissions from other RATs, e.g., NR-U, Wi-Fi, etc.) load across different unlicensed/shared channels. Other benefits from using the proposed resource selection and channel access method for SL communication in the unlicensed spectrum also include:

Less radio transmission peak-to-average power ratio (PAPR) issue means reduced or no clipping to an orthogonal frequency division multiplexing (OFDM) signal in 5G when it passes through a power amplifier, and therefore, the transmitted signals are more evenly amplified in the frequency domain without creating distortions and loss of information.

Able to utilize more radio resources that are available within the guard band PRBs for SL transmissions requiring more than one unlicensed/shared channel (RB set).

A void fragmentation of frequency resources that does not allow center unlicensed/shared channels to be used for transmission of large TB s across multiple consecutive channels (RB sets).

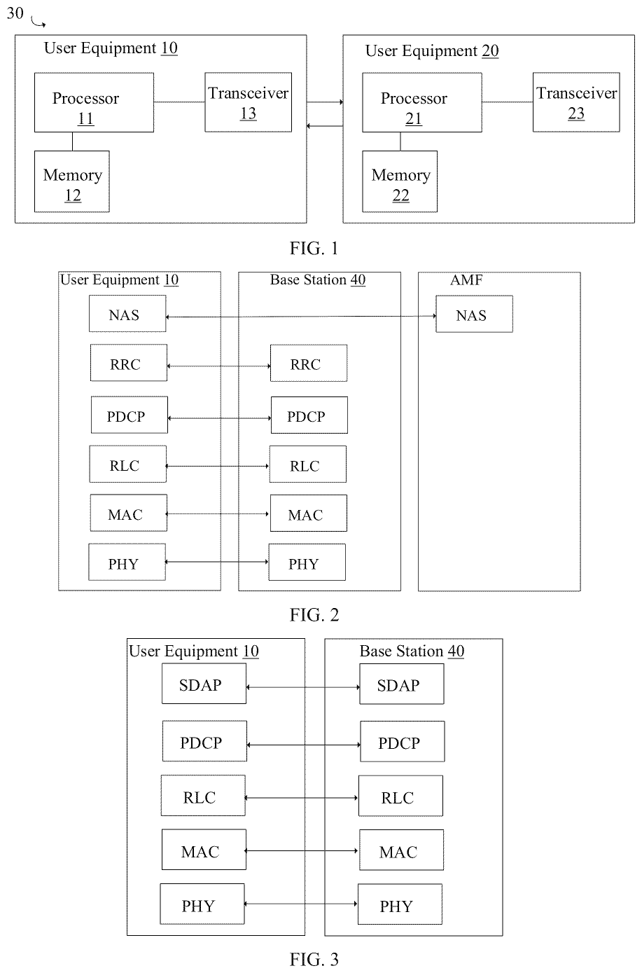

FIG. 1 illustrates that, in some embodiments, one or more user equipments (UEs) 10 (such as a first UE) and one or more user equipments (UEs) 20 (such as a second UE) of communication in a communication network system 30 according to an embodiment of the present disclosure are provided. The communication network system 30 includes one or more UEs 10 and one or more UE 20. The UE 10 may include a memory 12, a transceiver 13, and a processor 11 coupled to the memory 12 and the transceiver 13. The UE 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21 and transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

The communication between UEs relates to vehicle-to-everything (V2X) communication including vehicle-to-vehicle (V2V), vehicle-to-pedestrian (V2P), and vehicle-to-infrastructure/network (V2I/N) according to a sidelink technology developed under 3rd generation partnership project (3GPP) long term evolution (LTE) and new radio (NR) releases 17, 18 and beyond. UEs are communicated with each other directly via a sidelink interface such as a PC5 interface. Some embodiments of the present disclosure relate to sidelink communication technology in 3GPP NR release 17 and beyond, for example providing cellular-vehicle to everything (C-V2X) communication.

In some embodiments, the UE 10 may be a sidelink packet transport block (TB) transmission UE (Tx-UE). The UE 20 may be a sidelink packet TB reception UE (Rx-UE) or a peer UE. The sidelink packet TB Rx-UE can be configured to send ACK/NACK feedback to the packet TB Tx-UE. The peer UE 20 is another UE communicating with the Tx-UE 10 in a same SL unicast or groupcast session.

FIG. 2 illustrates an example user plane protocol stack according to an embodiment of the present disclosure. FIG. 2 illustrates that, in some embodiments, in the user plane protocol stack, where service data adaptation protocol (SDAP), packet data convergence protocol (PDCP), radio link control (RLC), and media access control (MAC) sublayers and physical (PHY) layer (also referred as first layer or layer 1 (L1) layer) may be terminated in a UE 10 and a base station 40 (such as gNB) on a network side. In an example, a PHY layer provides transport services to higher layers (e.g., MAC, RRC, etc.). In an example, services and functions of a MAC sublayer may comprise mapping between logical channels and transport channels, multiplexing/demultiplexing of MAC service data units (SDUs) belonging to one or different logical channels into/from transport blocks (TBs) delivered to/from the PHY layer, scheduling information reporting, error correction through hybrid automatic repeat request (HARQ) (e.g. one HARQ entity per carrier in case of carrier aggregation (CA)), priority handling between UEs by means of dynamic scheduling, priority handling between logical channels of one UE by means of logical channel prioritization, and/or padding. A MAC entity may support one or multiple numerologies and/or transmission timings. In an example, mapping restrictions in a logical channel prioritization may control which numerology and/or transmission timing a logical channel may use. In an example, an RLC sublayer may supports transparent mode (TM), unacknowledged mode (UM) and acknowledged mode (AM) transmission modes. The RLC configuration may be per logical channel with no dependency on numerologies and/or transmission time interval (TTI) durations. In an example, automatic repeat request (ARQ) may operate on any of the numerologies and/or TTI durations the logical channel is configured with. In an example, services and functions of the PDCP layer for the user plane may comprise sequence numbering, header compression, and decompression, transfer of user data, reordering and duplicate detection, PDCP PDU routing (e.g., in case of split bearers), retransmission of PDCP SDUs, ciphering, deciphering and integrity protection, PDCP SDU discard, PDCP re-establishment and data recovery for RLC AM, and/or duplication of PDCP PDUs. In an example, services and functions of SDAP may comprise mapping between a QoS flow and a data radio bearer. In an example, services and functions of SDAP may comprise mapping quality of service Indicator (QFI) in downlink (DL) and uplink (UL) packets. In an example, a protocol entity of SDAP may be configured for an individual PDU session.

FIG. 3 illustrates an example control plane protocol stack according to an embodiment of the present disclosure. FIG. 2 illustrates that, in some embodiments, in the control plane protocol stack where PDCP, RLC, and MAC sublayers and PHY layer may be terminated in a UE 10 and a base station 40 (such as gNB) on a network side and perform service and functions described above. In an example, RRC used to control a radio resource between the UE and a base station (such as a gNB). In an example, RRC may be terminated in a UE and the gNB on a network side. In an example, services and functions of RRC may comprise broadcast of system information related to AS and NAS, paging initiated by 5GC or RAN, establishment, maintenance and release of an RRC connection between the UE and RAN, security functions including key management, establishment, configuration, maintenance and release of signaling radio bearers (SRBs) and data radio bearers (DRBs), mobility functions, QoS management functions, UE measurement reporting and control of the reporting, detection of and recovery from radio link failure, and/or non-access stratum (NAS) message transfer to/from NAS from/to a UE. In an example, NAS control protocol may be terminated in the UE and AMF on a network side and may perform functions such as authentication, mobility management between a UE and an AMF for 3GPP access and non-3GPP access, and session management between a UE and a SMF for 3GPP access and non-3GPP access.

When a specific application is executed and a data communication service is required by the specific application in the UE, an application layer taking charge of executing the specific application provides the application-related information, that is, the application group/category/priority information/ID to the NAS layer. In this case, the application-related information may be pre-configured/defined in the UE. (Alternatively, the application-related information is received from the network to be provided from the AS (RRC) layer to the application layer, and when the application layer starts the data communication service, the application layer requests the information provision to the AS (RRC) layer to receive the information.)

In some embodiments, the processor 11 is configured to perform resource selection based on at least one of followings: selecting consecutive resources from resource block (RB) sets for sidelink transmission, avoid selecting resources in a same slot from different RB sets for simultaneous transmission, selecting resources in consecutive time slots within a channel occupancy time (COT) duration and within a same RB set, prioritizing or selecting resources for sidelink transmission within a self-initiated COT of the UE or a shared COT from another UE and within a same RB set as the self-initiated COT or the shared COT when a priority class of the sidelink transmission is equal to or larger than the self-initiated COT or the shared COT, performing channel busy ratio (CBR) and/or a channel occupancy ratio (CR) measurements per RB set and prioritizing or selecting a less loaded/congested RB set with lower measured CBR and/or CR values based on the CBR and/or the CR measurements, avoid selecting or exclude resources of an entire RB set based on one or more past listen-before-talk (LBT) failure reporting or a consistent LBT failure determination/indication, and prioritizing or selecting resources from one or both edge RB sets in a resource pool. This can solve issues in the prior art, gain higher success in accessing the unlicensed/shared channel(s) for sending sidelink data information, avoid uneven wireless traffic load across different unlicensed/shared channels, provide less radio transmission peak-to-average power ratio (PAPR) issue, utilize more radio resource, avoid fragmentation of frequency resources, provide a good communication performance, and/or provide high reliability.

FIG. 4 illustrates a resource selection method 410 for sidelink communication by a UE according to an embodiment of the present disclosure. In some embodiments, the method 410 includes: a block 412, performing resource selection, by the UE, based on at least one of followings: selecting resources from consecutive resource block (RB) sets for sidelink transmission, avoid selecting resources in a same slot from different RB sets for simultaneous transmission, selecting resources in consecutive time slots within a channel occupancy time (COT) duration and within a same RB set, prioritizing or selecting resources for sidelink transmission within a self-initiated COT of the UE or a shared COT from another UE and within a same RB set as the self-initiated COT or the shared COT when a priority class of the sidelink transmission is equal to or larger than the self-initiated COT or the shared COT, performing channel busy ratio (CBR) and/or a channel occupancy ratio (CR) measurements per RB set and prioritizing or selecting a less loaded/congested RB set with lower measured CBR and/or CR values based on the CBR and/or the CR measurements, avoid selecting or exclude resources of an entire RB set based on one or more past listen-before-talk (LBT) failure reporting or a consistent LBT failure determination/indication, and prioritizing or selecting resources from one or both edge RB sets in a resource pool. This can solve issues in the prior art, gain higher success in accessing the unlicensed/shared channel(s) for sending sidelink data information, avoid uneven wireless traffic load across different unlicensed/shared channels, provide less radio transmission peak-to-average power ratio (PAPR) issue, utilize more radio resource, avoid fragmentation of frequency resources, provide a good communication performance, and/or provide high reliability.

In some embodiments, selecting the resources from consecutive RB sets is used for sidelink transmission requiring one or more resources that span across more than one RB set, and/or the UE is configured to utilize resources in guard band physical resource blocks (PRBs) between the consecutive RB sets. In some embodiments, avoid selecting the resources in the same slot from the different R B sets for sidelink transmission of same or different medium access control (MAC) packet data units (PDUs) or transport blocks (TBs) requiring a resource size less than one RB set. In some embodiments, prioritizing or selecting the resources for sidelink transmission within the self-initiated COT or the shared COT is during an initial selection or a re-selection of resources for a MAC PDU or a TB. In some embodiments, prioritizing or selecting the resources from the one or both edge RB sets in the resource pool is used for transmission within a single RB set.

In some embodiments, the prioritizing or selecting the resources from the one or both edge RB sets in the resource pool is used for transmission within a single RB set when there is no available/candidate resource in an adjacent RB set. In some embodiments, when prioritizing or selecting the resources from the one or both edge RB sets in the resource pool, a ratio of available/candidate resources for the one or both edge RB sets in the resource pool is below a configured or pre-defined threshold. In some embodiments, the configured or pre-defined threshold is 70% or 80% of the available/candidate resources for the one or both edge RB sets in the resource pool. In some embodiments, when prioritizing or selecting the resources from the one or both edge RB sets in the resource pool, a ratio of available/candidate resources for the one or both edge RB sets in the resource pool is equal to or smaller than a ratio of available/candidate resources for one or more center RB sets.

In some embodiments, when prioritizing or selecting the resources from the one or both edge RB sets in the resource pool, a ratio of available/candidate resources for the one or both edge RB sets in the resource pool is larger than a ratio of available/candidate resources for one or more center RB sets. In some embodiments, X % refers to the ratio of the available/candidate resources for the edge RB sets, Y % refers to the ratio of the available/candidate resources for the center RB sets, and the difference between X % and Y % is less than or equal to a configured or pre-defined value. In some embodiments, the configured or pre-defined value is equal to 20%.

In the above embodiments, the term “configured” can refer to “pre-configured” and “network configured”. The term “pre-defined” or “pre-defined rules” in the present disclosure may be achieved by pre-storing corresponding codes, tables, or other manners for indicating relevant information in devices (e.g., including a UE and a network device). The specific implementation is not limited in the present disclosure. For example, “pre-defined” may refer to those defined in a protocol. It is also to be understood that in the disclosure, “protocol” may refer to a standard protocol in the field of communication, which may include, for example, a LTE protocol, NR protocol and relevant protocol applied in the future communication system, which is not limited in the present disclosure.

### Examples

In some embodiments, for the present disclosure of new resource selection methods for sidelink communication in a resource pool that spans across more than one unlicensed/shared frequency channel (also commonly known as RB set in a 5G system), it is proposed that the resource selection is performed by a sidelink (SL) transmitter UE (Tx-UE) in a more listen-before-talk (LBT)-aware and rule-based manner to avoid signal distortion in the radio frequency (RF) transmission and traffic congestion issues, and at the same time to achieve higher success in accessing the unlicensed/shared channel(s) for more reliable SL communication.

In SL mode 2 resource allocation, as previously mentioned, a sensing process is first performed within a SL resource pool by a Tx-UE to detect and exclude already reserved resources within a resource selection window (RSW). The remaining/available/non-reserved resources are then reported to a higher layer (i.e., medium access control MAC layer) for the final selection of one or more resources for (re) transmission of a MAC packet data unit (PDU)/transport block (TB). During the final selection by the MAC layer, multiple resources are randomly selected from the set of reported available resources. For SL communication in an unlicensed spectrum band (SL-U), as explained earlier, a resource pool may comprise more than one unlicensed/shared channel (i.e., multiple sets of resource blocks/RB sets) for supporting transmission of large data packets that requires multiple 20 MHz/RB sets. Based on the existing SL mode 2 resource sensing and exclusion procedure, the sensing operation would be performed for all unlicensed/shared channels (RB sets) within the resource pool and the exclusion and reporting of available resources may be also be done across the multiple unlicensed channels/RB sets. However, if the existing random selection process for the final selection of resources is still performed in the MAC layer, this could result in one or several of the following outcomes with undesirable consequences.

Selected resources may be scattered in different slots (e.g., with large transmission gaps) and in different unlicensed/shared channels (RB sets). When selected transmissions are in non-consecutive slots and/or with large gaps, likely they are not within the same COT length. Separate type 1 LBT channel access procedure for each transmission needs to be perform and hence the likelihood of LBT failure is increased due to the long LBT sensing time, as such. Furthermore, when LBT failure occurs, the UE reselects another resource with no guarantee that a new LBT channel access procedure will be a success, and further delay is added to the overall transmission latency.

Similarly, when the selected resources are scattered in different unlicensed channels/RB sets, two undesirable results/outcomes may happen. Firstly, for a large packet transmission, non-consecutive unlicensed channels/RB sets could be selected in the same slot and cause a high peak-to-average power ratio (PAPR) issue in the (radio frequency) transmission as explained earlier. Secondly, for small packet transmissions, even if resources in consecutive unlicensed channels/RB sets are selected in the same slot, it requires the UE to perform two separate LBT channel access procedure for each unlicensed channel/RB set. As explained earlier, the eventual transmission of one of the unlicensed channels/RB sets depend on LBT success in all of the unlicensed channels/RB sets (i.e., all or nothing operation). Furthermore, even when the LBT channel access is a success in all of the channels/RB sets, the high PAPR issue could still occur when the selected resources are not adjacent to each other in the frequency domain.

In a worst-case scenario, selected resources may be concentrated in an unlicensed/shared channel (RB set) that is more congested than others. In this case, it will heavily degrade the chances/likelihood of a successful LBT channel access due to the unlicensed channel/RB set is constantly occupied by other transmissions (including transmissions of other RATs, e.g., Wi-Fi, Bluetooth, LAA, etc.)

Another issue with random resource selection in the final selection of resources is the fragmentation of resources across the multiple unlicensed/shared channels (RB sets) within a resource pool, and subsequently resulting in a lack of blocks of continuous resources in the frequency domain for large packet size transmission.

### Proposed Resource Selection Methods and Rules

In order to minimize the necessity of a SL Tx-UE frequently performing a long type 1 LBT channel access procedure for its transmissions (and hence the risk of LBT failure), to avoid RF transmission issues in high PAPR/cubic metric and uneven wireless traffic load across different unlicensed/shared channels (RB sets), and to provide more resources that are contiguous in the frequency domain for large packet transmissions, it is proposed that one or more of the following resource selection methods can be adopted.

### Methods for Resolving/Improving the Resource Scattering Issue Across Multiple Unlicensed Channels RB Sets

### Exemplary Method 1

Consecutive RB sets are selected for SL transmission that requires a resource size larger than 1 unlicensed channel/RB set to reduce/avoid high PAPR problem in RF wireless transmissions and to improve radio resource utilization efficiency, since the guard band PRBs are also made usable without creating interference due to no channel/spectrum leakage is expected.

When selecting resources for large packet size transmissions (e.g., when the required number of resources per transmission is more than one unlicensed channel/RB set), the selection can be done such that only the resources in the adjacent unlicensed channels/RB sets are selected by the Tx-UE. By doing so, it can provide two important benefits. Generally, whenever there is a gap in the frequency resources used for wireless transmission in an orthogonal frequency division multiplexing (OFDM) symbol, depending on the size of the gap this tend produce a sharp peak in the time domain and suddenly drive the power amplifier in the transmitting device to a saturation level and cause a clipping effect to the high peak. This problem is commonly known and it can be measured by a PAPR level or sometimes known as cubic metric in the power amplifier. And whenever a clipping happens some amplitude information is lost in quadrature amplitude modulation (QAM) modulated wireless signal. Consequently, some data may become undecodable.

Secondly, guard band physical resource blocks (PRBs) that are in between two adjacent unlicensed/shared channels (RB sets) are now become useable and can be additionally utilized by the Tx-UE for modulating and transmitting its sidelink data. In wireless communication, a guard band is normally placed/allocated in between two adjacent radio channels/frequency bands to protect/guard against interference due to radio transmission leakage from each other. Naturally, frequency resources within the guard band may not be used for any radio transmission. On the other hand, when a device is transmitting in both radio channels, since the radio transmission covers both frequency portions/channels, there may be no interference created from one channel to the other channel due to no signal is filtered in between the two channels. As such, the guard band PRBs in SL-U can be utilized by the Tx-UE that selects resources for transmission in two adjacent unlicensed/RB sets. Moreover, the guard band PRBs can be utilized by the Tx-UE otherwise the aforementioned high PAPR/cubic metric issue may once again be a problem to the Tx-UE due to the frequency gap from the guard band PRBs.

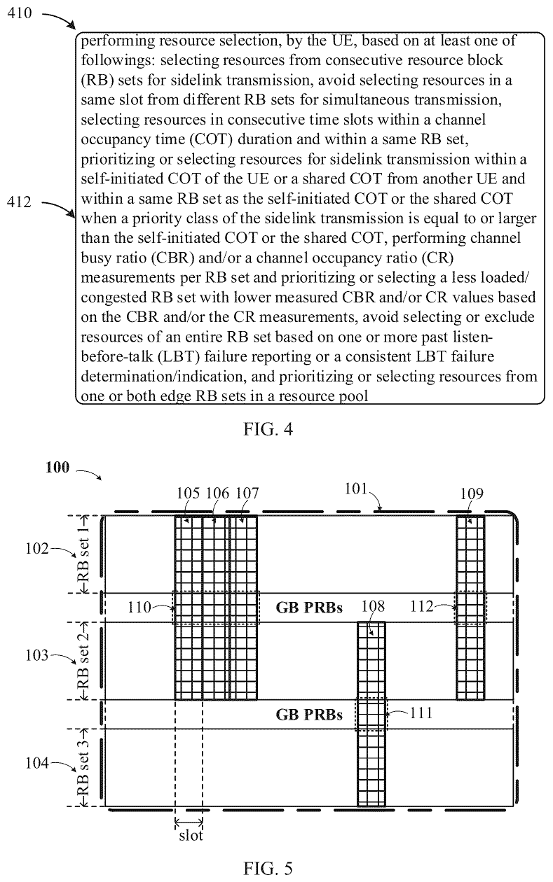

FIG. 5 illustrates an exemplary illustration of one of the proposed resource selection methods for SL-U communication based on selecting resources that are in adjacent channels/R B sets so that additional resources in the guard band PRBs can be utilized by the Tx-UE and the high PAPR issue due to frequency gaps can be avoided. FIG. 5 illustrates that, in some embodiments, in diagram 100, a sidelink resource pool 101 with a size in the frequency domain that covers three shared channels (i.e., RB set 1 102, RB set 2 103, RB set 3 104) in an unlicensed spectrum band is illustrated. As demonstrated, the Tx-UE selects resources in slot 105, 106, 107, 108, and 109 that each cover two consecutive/adjacent unlicensed channels/RB sets for transmitting large data MAC PDUs/TBs. Since in each slot the selected resource(s) covers across two adjacent RB sets, the additional resources from the guard band (GB) PRBs in 110, 111, and 112 can be also utilized by the Tx-UE for its SL transmissions.

### Exemplary Method 2

For SL transmission(s) of the same or different MAC PDUs/TBs that require a resource size less than 1 unlicensed channel/RB set, avoid selecting resources in a same slot from different unlicensed channels/RB sets for simultaneous radio transmission due to the aforementioned high PAPR/cubic metric issue and to avoid UE performing multi-channel access procedure issue (all or nothing) which has a higher chance of LBT failure and subsequently dropping both MAC PDUs/TBs.

In the case when a SL Tx-UE select resources for transmitting data packets with small sizes (e.g., when the required number of resources per transmission is less than one unlicensed channel/RB set), resources of the same slot from different unlicensed channels/RB sets can be avoided regardless whether the transmissions are intended for the same or different MAC PDUs/TBs. That is, when the Tx-UE/MAC layer selects from a set of reported available resources for SL transmission of one or more MAC PDU/TB, up to one resource can be selected in one slot (i.e., not more than one resource is allowed to be selected). This includes any existing selected resource from a past resource selection process. Overall, a maximum of one resource can be selected in a slot for SL transmission when the selected resource is smaller than one unlicensed channel/RB set. This rule/restriction is needed for the same reason as in exemplary method 1, where a high PAPR/cubic metric problem may occur whenever there is a transmission gap in the frequency domain in a transmitted carrier.

Another reason to avoid selecting resources from different unlicensed channels/RB sets is due to the multi-channel access procedure for SL, where an LBT channel access procedure needs to be performed by the Tx-UE for each of the intended unlicensed channel/R B set for transmission. If an LBT failure occurs for any of the intended unlicensed channel/RB set (i.e., even if LBT success in all other intended unlicensed channels/RB sets), none of the selected resources can be used (i.e., no MAC PDU/TB can be transmitted). Therefore, there is a higher chance of LBT success if resources are selected within the same unlicensed channel/RB set, since only one LBT channel access procedure needs to be performed.

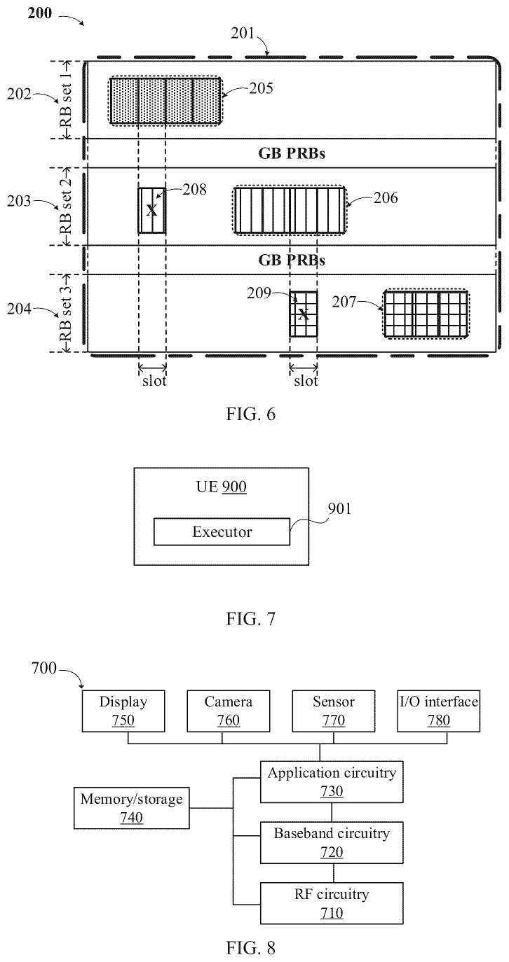

In reference to diagram 200 in FIG. 6, an exemplary illustration of the above proposed resource selection method for SL-U communication is illustrated based on selecting resources that are not overlapping in the same slot across different unlicensed channels/RB sets, so that the high PAPR/cubic metric problem due to large transmission gap in the frequency domain is avoided. FIG. 6 illustrates that, in diagram 200, a sidelink resource pool 201 with a size in the frequency domain that covers three shared channels (i.e., RB set 1 202, RB set 2 203, RB set 3 204) in an unlicensed spectrum band is illustrated. As demonstrated, the Tx-UE selects a set of resources 205 across multiple slots (i.e., not multiple channels/RB sets in a same slot) for transmission of one MAC PDU/TB to avoid the high PAPR/cubic metric problem and the need to perform the multi-channel access procedure, which is based on an all or nothing channel access principle. When the Tx-UE selects an additional set of resources 206 for transmission of another MAC PDU/TB, the same selection method/rule is applied. In that, the additional set of resources 206 are selected across multiple slots within a same unlicensed channel/RB set 203. It can be noted that, when selecting additional resources for another MAC PDU/TB, the Tx-UE may take into account of the existing selected resources 205 within the resource pool 201 and avoid selecting a resource 208 that would overlap with any of the existing selections. Similarly, if the Tx-UE may select a new set of resources for SL transmission of yet another new MAC PDU/TB, the new set of resources 207 may not span across multiple unlicensed channels/RB sets in the same slot and the selection can avoid a resource 209 that would overlap with any of the existing selections.

Methods for Resolving/Improving the Resource Scattering Issue Across Different Slots with Large Transmission Gaps

### Exemplary Method 3

A set of resources that are consecutive in time slots within a COT duration and within a same unlicensed channel/RB set may be selected by a TX-UE (e.g., for MCSt) to reduce/minimize the effort of UE performing a long type 1 LBT channel access procedure and the risk of LBT failure in gaining access to the unlicensed/shared channel (RB set).

In the aforementioned exemplary method 1 and exemplary method 2, the resource selection principle in the frequency domain (i.e., across multiple unlicensed channels/RB sets) is designed to avoid a certain undesirable RF transmission issue in wireless communication based on OFDM (i.e., high PAPR/cubic metric in the transmitted signal), to take advantage of the available otherwise empty resources in the guard band PRBs in between two unlicensed channels/RB sets, and to minimize the need for a Tx-UE to perform multi-channel access procedures in order to avoid the occurrence of nothing can be transmitted when the LBT channel access procedure is a failure for just one of the channels/RB sets.

For the proposed exemplary method 3, it is intended to resolve a different problem when selected resources are scattered across different slots with large transmission gaps. As described earlier, a type 1 LBT channel access procedure can be performed by a SL Tx-UE in order to gain access to an unlicensed/shared channel (RB set) before its planned transmission using a selected resource and to initiate a COT. Within the COT duration (the length of which depends on the priority class of the planned SL transmission), the Tx-UE has the right to transmit/occupy the channel continuously without a need to perform another Type 1 LBT channel access procedure. If there is a transmission gap longer than 16 μs or 25 μs, only a short type 2A or 2B LBT channel access procedure needs to be carried out to ensure the channel is still empty. And hence, if resources randomly selected by the Tx-UE spreads wildly across different slots with large gaps, then the Tx-UE may need to perform a type 1 LBT channel access procedure for every randomly selected resource before the planned transmission. As such, it is very costly to the Tx-UE and heavily exposed to the risk of LBT failure associated with the type 1 LBT.

Instead, in exemplary method 3, the Tx-UE may select resources in consecutive slots within a COT duration and within a same unlicensed channel/RB set (e.g., a MCSt scheme) to minimize the UE effort and the risk of LBT failure by performing type 1 LBT channel access procedure once to initiate a COT and perform MCSt within the COT duration. If a COT duration is not sufficient to cover all necessary (re) transmission of a MAC PDU/TB, more sets of resources for MCSt can be selected for the remaining transmissions. In reference to diagram 200 in FIG. 6, three different sets of resources 205, 206, 207 that are consecutive in time slots are selected by the Tx-UE in three different unlicensed channels/RB sets 202, 203, 204 for SL transmissions of three different MAC PDUs/TBs. Note that, based on the proposed resource selection in exemplary method 2, these three sets of resources (e.g., for MCSt) are not overlap in time (and thus the risk of multi-channel access is avoided). Since a type 1 LBT channel access procedure may be performed at the beginning of each set of resources to initiate a new COT, it is not necessary for the three sets of resources 205, 206, 207 to be within the same unlicensed channel/RB set.

### Exemplary Method 4

A Tx-UE may prioritize/select resources for SL transmission within a self-initiate COT or a shared COT from another UE (if available) and within the same unlicensed channel/RB set as the COT as long as the priority class of the SL transmission is equal to or larger than the initiated or the shared COT. This resource selection method can be adopted to minimize the UE effort of performing a new type 1 LBT channel access procedure for every SL transmission. The prioritization/selection of resources within a self-initiate COT or a shared COT from another UE could be performed by the Tx-UE during the initial selection or re-selection of resources (including replacement in resource re-evaluation and pre-emption checking procedures) for a MAC PDU/TB.

Another/different time domain related resource selection rule/method that can be adopted by a Tx-UE to minimize its effort in gaining access to an unlicensed channel/RB set and to reduce the risk of getting a LBT failure is to prioritize or select resources for SL transmission within a COT which is self-initiated or shared from another UE and within the same unlicensed channel/R B set as the COT. When the Tx-UE obtains a COT sharing information from another UE, the Tx-UE is able to utilize the shared COT for a SL transmission as long as the priority class of the SL transmission is equal to or larger than the shared COT. And hence, the Tx-UE can take advantage of a self-initiated COT or a shared COT from another UE as part of the SL resource (re) selection and/or re-evaluation/pre-emption checking procedures to improve the likelihood of gaining the access to the unlicensed channel/RB set and the ease of performing a long type 1 channel access procedure with uncertain outcome.

Methods for Resolving the Issue of Selecting Resources from Congested Unlicensed Channels/RB Sets

### Exemplary Method 5

UE performs channel busy ratio (CBR) and/or channel occupancy ratio (CR) measurements per RB set and prioritizes less loaded/congested unlicensed channel/RB set with lower measured CBR and/or CR values for resource selection.

In a SL resource pool that contains/covers more than one unlicensed channels/RB sets, it is likely that one unlicensed channel/RB set is busier and more congested than others. Generally, when one unlicensed channel/RB set is busy, it is congested with user traffics with lots of transmissions from different UEs/devices in the channel. As such, it is more difficult to gain access to a busy/congested unlicensed channel/RB set than a non-busy one when a type 1 LBT channel access procedure needs to be performed by a Tx-UE. Therefore, a new resource selection method is proposed that a Tx-UE can perform a CBR and/or a CR measurement on the unlicensed channels/RB sets within a SL resource pool and the selection of resources for SL transmission can take into account of the measured CBR and/or CR values. For example, an unlicensed channel/RB set with lower measured CBR and/or CR value(s) can be prioritized for resource selection than other unlicensed channels/RB sets, in order to balance uneven congestion loading across different unlicensed channels/RB sets within a SL resource pool.

### Exemplary Method 6

A void selecting (in MAC layer) or UE exclusion of an entire RB set of resources (in L1 procedure) based on one or more of past LBT failure reporting or a consistent LBT failure determination/indication.

Another mechanism in determining whether an unlicensed/shared channel (RB set) is busy or congested within a resource pool is to base on a number of LBT failures reported to a higher layer (e.g., the MAC layer). In a SL-U system, a LBT failure in the PHY layer is always reported to the higher layer such that a replacement resource is selected for the retransmission of the data packet. In the higher layer, a counter is incremented whenever a LBT failure is reported. When the counter reaches a certain value within a pre-defined time period, a consistent LBT failure is determined by the higher layer. Therefore, if a Tx-UE is experiencing/reporting LBT failures for an unlicensed channel/RB set more than others or the number of reported LBT failures for an unlicensed channel/RB set is above a certain threshold value (which could be (pre-)configured or pre-defined), the Tx-UE can avoid selecting resources from that unlicensed channel/RB set, since the channel/RB set is heavily congested. Alternatively, if a consistent LBT failure is determined for an unlicensed channel/RB set, either the MAC layer can avoid selecting resources from the unlicensed channel/RB set, or the consistent LBT failure may be indicated to L1/the PHY layer for an unlicensed channel/RB set and the L1 may exclude all resources of the indicated unlicensed channel/RB set from the candidate resource set (S_{A}).

### Method for Resolving or Improving the Resource Fragmentation Issue for SL Transmission Across Multiple Unlicensed Channels/RB Sets

### Exemplary Method 7

Candidate resources in the edge unlicensed channels/RB sets can be selected or prioritized for selection for transmissions only within a single unlicensed channel/RB set, to avoid center unlicensed channels/RB set(s) been overloaded/congested and left with insufficient resources for transmitting a large size MAC PDU/TB that requires multi-consecutive unlicensed channels/RB sets.

In SL-U communication, different UE may have different sizes of packets to be transmitted over multiple unlicensed channels/RB sets within a SL resource pool. As explained in exemplary method 1 above, a Tx-UE can select resources from consecutive/adjacent unlicensed channels/RB sets to transmit packets with a large size to avoid the high PAPR/cubic metric problem that is commonly associated with OFDM signal transmissions. On the other hand, there is no restriction or rule on which unlicensed channel/RB set that can be selected for transmitting packets with a small size (i.e., a required number of resources is smaller than an unlicensed channel/RB set). As such, by selecting resources randomly in the higher layer, the selected resources for transmitting small packets would be distributed across all the unlicensed channels/RB sets within a resource pool. When there is a high congestion in the resource pool, it will become difficult for a Tx-UE to find one or the required number of sets of resources that are in consecutive/adjacent unlicensed channels/RB sets for transmitting large size packets. Hence, it is beneficial to keep center unlicensed channel(s)/RB sets within a resource pool empty and available such that large size packets can be transmitted in consecutive/adjacent unlicensed channels/RB sets. Therefore, it is proposed that one or both of unlicensed channels/RB sets at the edges of a sidelink resource pool are prioritized/selected for transmission of small size MAC PDUs/TBs (i.e., the required number of resources smaller than the total number of resources per unlicensed channel/RB set). The prioritization or selection of resources from an edge unlicensed channel/RB set could be based on at least one of the followings.

A resource in an edge unlicensed channel/RB set cannot be used for SL transmission across multiple consecutive/adjacent unlicensed channels/RB sets. For example, when there is no available/candidate resource in the adjacent unlicensed channel/RB set. The resource can be selected or prioritized for selection for transmission of a small size MAC PDU/TB.

The ratio of available resources for the edge unlicensed channels/RB sets is below a (pre-) configured or pre-defined threshold (e.g., 70%, 80%). The ratio of available resources for the edge unlicensed channels/RB sets is equal to or smaller than the ratio of available resources for the center unlicensed channel(s)/RB set(s). The ratio of available resources for the edge unlicensed channels/RB sets (X %) is larger than the ratio of available resources for the center unlicensed channels/RB sets (Y %), and the difference between X and Y is less than or equal to a (pre-)configured or pre-defined value (Z). E.g., X−Y≤20%, where Z is 20%.

In summary, in order to minimize the necessity of a SL Tx-UE frequently performing a long type 1 LBT channel access procedure for its transmissions (and hence the risk of LBT failure), to avoid RF transmission issues in high PAPR/cubic metric and uneven wireless traffic (including transmissions from other RATs, e.g., NR-U, Wi-Fi, etc.) load across different unlicensed/shared channels (RB sets), and to provide more resources that are contiguous in the frequency domain for large packet transmissions, one or more of the following proposed resource selection methods can be adopted. Methods for resolving/improving the resource scattering issue across multiple unlicensed channels/RB sets are illustrated in the above exemplary methods 1 and 2. Methods for resolving/improving the resource scattering issue across different slots with large transmission gaps are illustrated in the above exemplary methods 3 and 4. Methods for resolving the issue of selecting resources from congested unlicensed channels/RB sets are illustrated in the above exemplary methods 5 and 6. Method for resolving or improving the resource fragmentation issue for SL transmission across multiple unlicensed channels/RB sets is illustrated in the above exemplary method 7.

FIG. 7 illustrates a UE 900 for wireless communication according to an embodiment of the present disclosure. The UE 900 includes an executor 901 configured to perform resource selection based on at least one of followings: selecting consecutive resources from resource block (RB) sets for sidelink transmission, avoid selecting resources in a same slot from different RB sets for simultaneous transmission, selecting resources in consecutive time slots within a channel occupancy time (COT) duration and within a same RB set, prioritizing or selecting resources for sidelink transmission within a self-initiated COT of the UE or a shared COT from another UE and within a same RB set as the self-initiated COT or the shared COT when a priority class of the sidelink transmission is equal to or larger than the self-initiated COT or the shared COT, performing channel busy ratio (CBR) and/or a channel occupancy ratio (CR) measurements per RB set and prioritizing or selecting a less loaded/congested RB set with lower measured CBR and/or CR values based on the CBR and/or the CR measurements, avoid selecting or exclude resources of an entire RB set based on one or more past listen-before-talk (LBT) failure reporting or a consistent LBT failure determination/indication, and prioritizing or selecting resources from one or both edge RB sets in a resource pool. This can solve issues in the prior art, gain higher success in accessing the unlicensed/shared channel(s) for sending sidelink data information, avoid uneven wireless traffic load across different unlicensed/shared channels, provide less radio transmission peak-to-average power ratio (PAPR) issue, utilize more radio resource, avoid fragmentation of frequency resources, provide a good communication performance, and/or provide high reliability.

In some embodiments, the executor 901 is configured to select the resources from consecutive RB sets used for sidelink transmission requiring one or more resources that span across more than one RB set, and/or the executor 901 is configured to utilize resources in guard band physical resource blocks (PRBs) between the consecutive RB sets. In some embodiments, the executor 901 is configured to avoid selecting the resources in the same slot from the different RB sets for sidelink transmission of same or different medium access control (MAC) packet data units (PDUs) or transport blocks (TBs) requiring a resource size less than one RB set. In some embodiments, the executor 901 is configured to prioritize or select the resources for sidelink transmission within the self-initiated COT or the shared COT during an initial selection or a re-selection of resources for a MAC PDU or a TB. In some embodiments, the executor 901 is configured to prioritize or select the resources from the one or both edge RB sets in the resource pool used for transmission within a single RB set.

In some embodiments, the executor 901 is configured to prioritize or select the resources from the one or both edge RB sets in the resource pool used for transmission within a single RB set when there is no available/candidate resource in an adjacent RB set. In some embodiments, when the executor 901 prioritizes or selects the resources from the one or both edge RB sets in the resource pool, a ratio of available/candidate resources for the one or both edge RB sets in the resource pool is below a configured or pre-defined threshold. In some embodiments, the configured or pre-defined threshold is 70% or 80% of the available/candidate resources for the one or both edge RB sets in the resource pool. In some embodiments, when the executor 901 prioritizes or selects the resources from the one or both edge RB sets in the resource pool, a ratio of available/candidate resources for the one or both edge RB sets in the resource pool is equal to or smaller than a ratio of available/candidate resources for one or more center RB sets.

In some embodiments, when the executor 901 prioritizes or selects the resources from the one or both edge RB sets in the resource pool, a ratio of available/candidate resources for the one or both edge RB sets in the resource pool is larger than a ratio of available/candidate resources for one or more center RB sets. In some embodiments, X % refers to the ratio of the available/candidate resources for the edge RB sets, Y % refers to the ratio of the available/candidate resources for the center RB sets, and the difference between X % and Y % is less than or equal to a configured or pre-defined value. In some embodiments, the configured or pre-defined value is equal to 20%.

Commercial interests for some embodiments are as follows. 1. Solving issues in the prior art. 2. Gaining higher success in accessing the unlicensed/shared channel(s) for sending sidelink data information. 3. Avoiding uneven wireless traffic load across different unlicensed/shared channels. 4. Providing less radio transmission peak-to-average power ratio (PAPR) issue. 5. Utilizing more radio resource. 6. Avoiding fragmentation of frequency resources. 7. Providing a good communication performance. 8. Providing high reliability. 9. Providing good communication performance. 10. Providing high reliability. 11. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, smart watches, wireless earbuds, wireless headphones, communication devices, remote control vehicles, and robots for public safety use, AR/VR device maker for example gaming, conference/seminar, education purposes, smart home appliances including TV, stereo, speakers, lights, door bells, locks, cameras, conferencing headsets, and etc., smart factory and warehouse equipment including IIOT devices, robots, robotic arms, and simply just between production machines. In some embodiments, commercial interest for the disclosed invention and business importance includes lowering power consumption for wireless communication means longer operating time for the device and/or better user experience and product satisfaction from longer operating time between battery charging. Some embodiments of the present disclosure are a combination of “techniques/processes” that can be adopted in 3GPP specification to create an end product. Some embodiments of the present disclosure relate to mobile cellular communication technology in 3GPP NR Releases 17, 18, and beyond for providing direct device-to-device (D2D) wireless communication services.

FIG. 8 is a block diagram of an example system 700 for wireless communication according to an embodiment of the present disclosure. Embodiments described herein may be implemented into the system using any suitably configured hardware and/or software. FIG. 8 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated.

The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WM A N), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network.

In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules.

In some embodiments, some or all of the constituent components of the baseband circuitry, the application circuitry, and/or the memory/storage may be implemented together on a system on a chip (SOC).

The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, a AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan.

A person having ordinary skill in the art can use different ways to realize the function for each specific application while such realizations cannot go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A resource selection method for sidelink communication by a user equipment (UE), comprising:
performing resource selection, by the UE, based on at least one of followings:
selecting resources from consecutive resource block (R B) sets for sidelink transmission;
avoiding selecting resources in a same slot from different RB sets for simultaneous transmission;
selecting resources in consecutive time slots within a channel occupancy time (COT) duration and within a same RB set;
prioritizing or selecting resources for sidelink transmission within a self-initiated COT of the UE or a shared COT from another UE and within a same RB set as the self-initiated COT or the shared COT when a priority class of the sidelink transmission is equal to or larger than the self-initiated COT or the shared COT;
performing channel busy ratio (CBR) and/or a channel occupancy ratio (CR) measurements per RB set and prioritizing or selecting a less loaded/congested RB set with lower measured CBR and/or CR values based on the CBR and/or the CR measurements;
avoiding selecting or exclude resources of an entire RB set based on one or more past listen-before-talk (LBT) failure reporting or a consistent LBT failure determination/indication; and
prioritizing or selecting resources from one or both edge RB sets in a resource pool.

2. The method of claim 1, wherein selecting the resources from consecutive RB sets is used for sidelink transmission requiring one or more resources that span across more than one RB set, and/or the UE is configured to utilize resources in guard band physical resource blocks (PRBs) between the consecutive RB sets.

3. The method of claim 1, wherein avoid selecting the resources in the same slot from the different RB sets for sidelink transmission of same or different medium access control (MAC) packet data units (PDUs) or transport blocks (TBs) requiring a resource size less than one RB set.

4. The method of claim 1, wherein prioritizing or selecting the resources for sidelink transmission within the self-initiated COT or the shared COT is during an initial selection or a re-selection of resources for a MAC PDU or a TB.

5. The method of claim 1, wherein prioritizing or selecting the resources from the one or both edge RB sets in the resource pool is used for transmission within a single RB set.

6. The method of claim 1, wherein the prioritizing or selecting the resources from the one or both edge RB sets in the resource pool is used for transmission within a single RB set when there is no available/candidate resource in an adjacent RB set.

7. The method of claim 1, wherein when prioritizing or selecting the resources from the one or both edge RB sets in the resource pool, a ratio of available/candidate resources for the one or both edge RB sets in the resource pool is below a configured or pre-defined threshold.

8. The method of claim 7, wherein the configured or pre-defined threshold is 70% or 80% of the available/candidate resources for the one or both edge RB sets in the resource pool.

9. The method of claim 1, wherein when prioritizing or selecting the resources from the one or both edge RB sets in the resource pool, a ratio of available/candidate resources for the one or both edge RB sets in the resource pool is equal to or smaller than a ratio of available/candidate resources for one or more center RB sets.

10. The method of claim 1, wherein when prioritizing or selecting the resources from the one or both edge RB sets in the resource pool, a ratio of available/candidate resources for the one or both edge RB sets in the resource pool is larger than a ratio of available/candidate resources for one or more center RB sets.

11. The method of claim 10, wherein X % refers to the ratio of the available/candidate resources for the edge RB sets, Y % refers to the ratio of the available/candidate resources for the center RB sets, and the difference between X % and Y % is less than or equal to a configured or pre-defined value.

12. The method of claim 11, wherein the configured or pre-defined value is equal to 20%.

13. A user equipment (UE), comprising:
a memory storing instructions;
a transceiver; and
a processor coupled to the memory and the transceiver;
wherein when the instructions are executed by the processor, the UE is caused to perform resource selection based on at least one of followings:
selecting resources from consecutive resource block (RB) sets for sidelink transmission;
avoiding selecting resources in a same slot from different RB sets for simultaneous transmission;
selecting resources in consecutive time slots within a channel occupancy time (COT) duration and within a same RB set;
prioritizing or selecting resources for sidelink transmission within a self-initiated COT of the UE or a shared COT from another UE and within a same RB set as the self-initiated COT or the shared COT when a priority class of the sidelink transmission is equal to or larger than the self-initiated COT or the shared COT;
performing channel busy ratio (CBR) and/or a channel occupancy ratio (CR) measurements per RB set and prioritizing or selecting a less loaded/congested RB set with lower measured CBR and/or CR values based on the CBR and/or the CR measurements;
avoiding selecting or exclude resources of an entire RB set based on one or more past listen-before-talk (LBT) failure reporting or a consistent LBT failure determination/indication; and
prioritizing or selecting resources from one or both edge RB sets in a resource pool.

14. The UE of claim 13, wherein selecting the resources from consecutive RB sets is used for sidelink transmission requiring one or more resources that span across more than one RB set, and/or the UE is configured to utilize resources in guard band physical resource blocks (PRBs) between the consecutive RB sets.

15. The UE of claim 13, wherein avoid selecting the resources in the same slot from the different RB sets for sidelink transmission of same or different medium access control (MAC) packet data units (PDUs) or transport blocks (TBs) requiring a resource size less than one RB set.

16. The UE of claim 13, wherein prioritizing or selecting the resources for sidelink transmission within the self-initiated COT or the shared COT is during an initial selection or a re-selection of resources for a MAC PDU or a TB.

17. A non-transitory machine-readable storage medium having stored thereon instructions that, when executed by a computer, cause the computer to perform resource selection based on at least one of followings:
selecting resources from consecutive resource block (RB) sets for sidelink transmission;
avoiding selecting resources in a same slot from different RB sets for simultaneous transmission;
selecting resources in consecutive time slots within a channel occupancy time (COT) duration and within a same RB set;
prioritizing or selecting resources for sidelink transmission within a self-initiated COT of a user equipment (UE) or a shared COT from another UE and within a same RB set as the self-initiated COT or the shared COT when a priority class of the sidelink transmission is equal to or larger than the self-initiated COT or the shared COT;
performing channel busy ratio (CBR) and/or a channel occupancy ratio (CR) measurements per RB set and prioritizing or selecting a less loaded/congested RB set with lower measured CBR and/or CR values based on the CBR and/or the CR measurements;
avoiding selecting or exclude resources of an entire RB set based on one or more past listen-before-talk (LBT) failure reporting or a consistent LBT failure determination/indication; and
prioritizing or selecting resources from one or both edge RB sets in a resource pool.

18. The non-transitory machine-readable storage medium of claim 17, wherein selecting the resources from consecutive RB sets is used for sidelink transmission requiring one or more resources that span across more than one RB set, and/or the UE is configured to utilize resources in guard band physical resource blocks (PRBs) between the consecutive RB sets.

19. The non-transitory machine-readable storage medium of claim 17, wherein prioritizing or selecting the resources for sidelink transmission within the self-initiated COT or the shared COT is during an initial selection or a re-selection of resources for a MAC PDU or a TB.

20. The non-transitory machine-readable storage medium of claim 17, wherein prioritizing or selecting the resources from the one or both edge RB sets in the resource pool is used for transmission within a single RB set.
